(19) United States
(12) Patent Application Publication
(10) Pub. No.: US 2014/0222397 A1
(43) Pub. Date: Aug. 7, 2014

(54) FRONT-END SIGNAL GENERATOR FOR HARDWARE IN-THE-LOOP SIMULATION

(71) Applicant: BAE Systems Information and Electronic Systems Integration Inc., Nashua, NH (US)

(72) Inventors: Jeffrey L JEW, Brookline, NH (US); Dennis R. CLARK, New Boston, NH (US); Nathan D. SMITH, Merrimack, NH (US); Forrest C. VATTER, Bedford, NH (US); Anthony MAHAR, Merrimack, NH (US)

(73) Assignee: BAE Systems Information and Electronic Systems Integration Inc., Nashua, NH (US)

(21) Appl. No.: 13/961,919

(22) Filed: Aug. 8, 2013

Related U.S. Application Data
(60) Provisional application No. 61/680,759, filed on Aug. 8, 2012.

(51) Int. Cl. G06F 17/50

(52) U.S. Cl. CPC G06F 17/5036
USPC 703/2

(57) ABSTRACT

A front-end signal generator for hardware-in-the-loop simulators of a simulated missile is disclosed. The front-end signal generator is driven by the Digital Scene And Reticle Simulation-Hardware In The Loop (DSARS-HITL) simulator. The simulator utilizes a computer to calculate irradiance on an Electro-Optical/Infrared (EO/IR) detector. The generator converts irradiance values into voltages that are injected into the missile's electronics during simulation. The conversion is done with low latency and a high dynamic range sufficient for hardware-in-the-loop simulation. The generator is capable of emulating laser pulse inputs that would be present during laser-based jammer countermeasures. Computer control of the generator occurs via front-panel-data-port (FPDP).

### CROSS-REFERENCE TO RELATED APPLICATIONS

This Application claims rights under 35 USC §119(e) from U.S. Application Ser. No. 61/680,759 filed 8 Aug. 2012 the contents of which are incorporated herein by reference.

### TECHNICAL FIELD

Embodiments are generally related Hardware-In-the Loop (HIL) simulations. Embodiments are also related to signal generators used for HIL simulations. Embodiments are additionally related to front-end signal generator for hardware-in-the-loop simulators of a simulated missile.

### BACKGROUND OF THE INVENTION

An electronic countermeasure (ECM) is an electrical or electronic device designed to trick or deceive radar, sonar or other detection systems, mostly utilizing infrared (IR) or lasers. It may be used both offensively and defensively to deny targeting information to an enemy. ECM systems generally make pseudo targets appear to the enemy, or make the real target appear to disappear or move about randomly. It is used effectively to protect aircraft from guided missiles. Majority of combat forces utilize ECM to protect their aircraft from attack. It has also been deployed by military ships and recently on some advanced tanks to fool laser/IR guided missiles.

The wide proliferation of IR missiles both air-air and surface-to-air has led to the development of different types of infrared countermeasure systems. This includes systems such as cued IR fares, towed IR decoys, omnidirectional on-board jammers and lamps and laser based directable jammers. Of these types the only effective jammers for protection of large aircraft against the large inventory of missiles is the directable laser jammer, also known as DIRCM or the Directed Infrared Countermeasure System. DIRCM systems operates based on a cue from a missile's warning system that slews a pointing and tracking sensor to track the threat missiles and then emits laser jammer radiation onto the missile dome. These systems are co-located on the aircraft and emit modulated waveforms which deceive the missile guidance. The on-board systems are designed to operate on the centerline of the missile's axis.

Infrared homing is a passive missile guidance system that uses the emission from a target of electromagnetic radiation in the infrared part of the spectrum to track and follow it. Missiles which use infrared seeking are often referred to as “heat-seekers”, since infrared (IR) is just below the visible spectrum of light in frequency and is radiated strongly by hot bodies. Many objects generate and retain heat are especially visible in the infra-red wavelengths of light compared to objects in the background.

A (decoy) flare is an aerial infrared countermeasure to counter an infrared homing (“heat seeking”) surface-to-air missile or air-to-air missile. Flares are commonly composed of a pyrotechnic composition based on magnesium or another hot-burning metal, with burning temperature equal to or hotter than engine exhaust. The aim is to make the infrared-guided missile seek out the heat signature from the flare rather than the aircraft's engines.

Hardware-in-the-loop (HIL) simulation is a technique that is used in the development and test of complex real-time embedded systems. HIL simulation provides an effective platform by adding the complexity of the plant under control to the test platform. The complexity of the plant under control is included in test and development by adding a mathematical representation of all related dynamic systems.

HIL simulation for radar systems have evolved from radar-jamming. Digital Radio Frequency Memory (DRFM) systems are typically used to create false targets to confuse the radar in the battlefield, but these same systems can simulate a target in the laboratory. This configuration allows for the testing and evaluation of the radar system, reducing the need for flight trails (for airborne radar systems) and field tests (for search or tracking radars), and can give an early indication to the susceptibility of the radar to Electronic Warfare (EW) techniques.

Current hardware-in-the-loop simulators have insufficient dynamic ranges and signal injection techniques to evaluate certain laser jamming countermeasures. Legacy simulators also have signal injection limitations that curtail the precision and dynamic range of other radiative sources of concern such as benign targets, flares, and other non-laser jammers.

A need, therefore exists, for a way to increase the dynamic range to effectively evaluate laser jammer countermeasures against missiles that employ passive homing techniques.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the present invention to provide for Hardware-In-the Loop (HIL) simulations.

It is another aspect of the disclosed embodiment to provide for signal generators used for HIL simulations.

It is a further aspect of the disclosed embodiment to provide front-end signal generator for hardware-in-the-loop simulators of a simulated missile.

The aforementioned aspects and other objectives and advantages can now be achieved as described herein. A front-end signal generator for hardware-in-the-loop simulators of a simulated missile is disclosed. The front-end signal generator is driven by the Digital Scene and Reticle Simulation-Hardware in the Loop (DSARS-HITL) simulator. The simulator utilizes a computer to calculate irradiance on an Electro-Optical/Infrared (EO/IR) detector. The generator converts irradiance values into voltages that are injected into the missile's electronics during simulation. The conversion is done with low latency and a high dynamic range sufficient for hardware-in-the-loop simulation.

The generator is capable of emulating laser pulse inputs that would be present during laser-based jammer countermeasures. Computer control of the generator occurs via front-panel-data-port (FPDP). The signal generator provides increased dynamic range and computer-controlled signal injection to effectively evaluate laser jammer countermeasures against missiles that employ passive homing techniques.

### BRIEF DESCRIPTION OF THE DRAWINGS

The accompanying figures, in which like reference numerals refer to identical or functionally-similar elements throughout the separate views and which are incorporated in and form a part of the specification, further illustrate the disclosed embodiments and, together with the detailed description of the invention, serve to explain the principles of the disclosed embodiments.

FIG. 1 illustrates a schematic block diagram of a system for hardware-in-loop simulation of a missile, by utilizing a front-end signal generator, in accordance with the disclosed embodiments; and

FIG. 2 illustrates a flow chart depicting the process of generating front-end signal for a hardware-in-the-loop simulator of a simulated missile, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

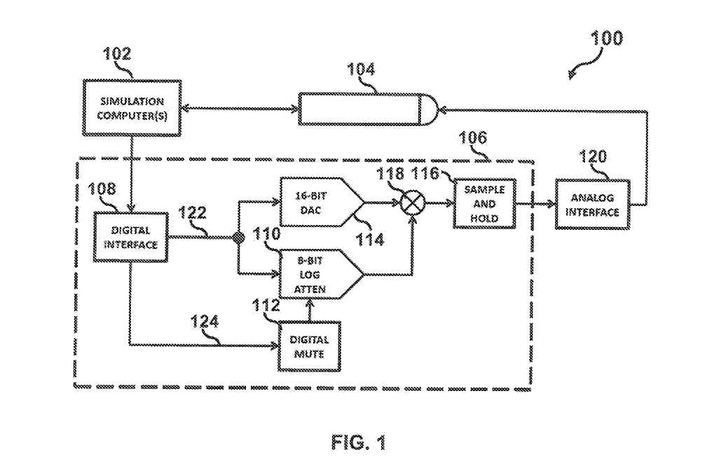

FIG. 1 illustrates a schematic block diagram of a system 100 for hardware-in-loop simulation of a missile 104, by utilizing a front-end signal generator 106, in accordance with the disclosed embodiments. A hardware-in-the-loop simulator utilizes the simulation computer(s) 102 for calculating irradiance on an EO/IR detector of the missile 104. The irradiance values have all possible range of optical or IR rays detected by EO/IR detector including rays during laser jamming countermeasures.

Note that the EO/IR detector receives signals from a source like an aircraft that induce laser jamming countermeasures when the aircraft detects the missile in real time. The HIL is utilized for computer controlled testing of analog electronic device like the missile 104 for all possible range of optical or IR rays.

The digital interface 108 receives irradiance values from the stimulation computer(s). The signal generator 106 comprises electronics that are utilized for converting irradiance values into voltages that are injected into the electronics of the missile 104 during simulation. A sixteen-Bit Digital to Analog Converter (DAC) 114 and a 8-Bit logarithmic attenuator 110 receives intensity control signal 122 of irradiance values and a digital mute 112 receives pulse width and repetition frequency control signals 124 of irradiance values.

In general a logarithmic resistor ladder is an electronic circuit composed of a series of resistors and switches, designed to create an attenuation from an input to an output signal, where the logarithm of the attenuation ratio is proportional to a digital code word that represents the state of the switches. The digital mute 112 is desirable to prevent a noise generated when the supply of the signal generator 106 is interrupted due to equipment/failure, and thereby prevent damage to the equipment connected to the later stage.

A summer 118 couples analog signal from DAC 114 and attenuation signal from logarithmic attenuator 110. A sample and hold circuit 116 utilized in digital to analog converter 114 eliminates variations in input signal that can corrupt the conversion process. The analog signal from sample and hold circuit 116 is fed to missile 104 through an analog interface 120. The signal generator 106 is a Jam Lab Front End Signal Generator (JLFESG) utilized for precise, real-time computer control for front-end signal injection due to all radiative sources of concern. The signal generator 106 is a six channel device including four conventional sources and two laser hammer sources.

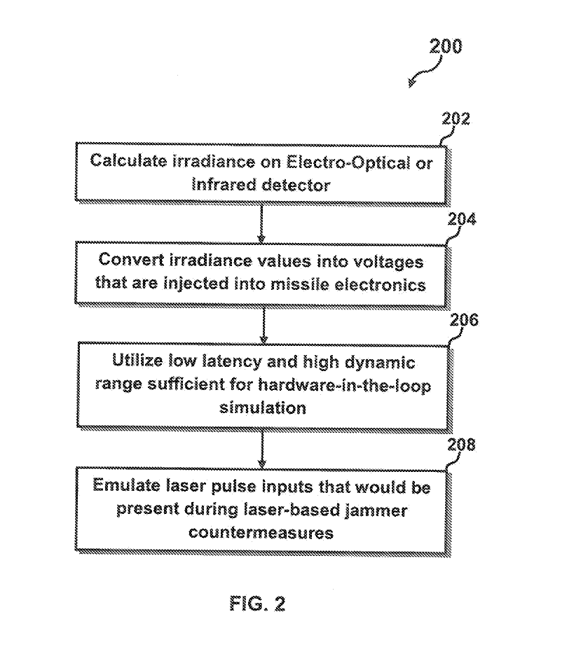

Referring to FIG. 2, a flow chart illustrating the process 200 of generating front-end signal for a hardware-in-the-loop simulator of a simulated missile is depicted. The simulator calculates irradiance on Electro-Optical or Infrared detector as said at block 202. Then, as illustrated at block 204, the irradiance values are converted into voltages that are injected into missile electronics. The conversion is done by utilizing low latency (on the order of 10 microseconds) and a high dynamic range (more than 100 dB) sufficient for hardware-in-the-loop simulation as said at block 206. As depicted at block 208, the signal generator is capable of emulating laser pulse inputs that would be present during laser-based jammer countermeasures. The computer control of the generator board occurs via Front-Panel-Data-Port (FPDP).

Those skilled in the art will appreciate that the generator of the present invention provides increased dynamic range; computer-controlled signal injection; and that irradiance due to individual sources can now be summed using double-precision floating point arithmetic. Those skilled in the art will also appreciate that the JLFESG board can be applied to any application that requires precise, real-time computer-based stimulation of analog electronics, including applications that require pulse inputs with programmable pulse repetition frequency (PRF) and pulse width (PW).

While the present invention has been described in connection with the preferred embodiments of the various figures, it is to be understood that other similar embodiments may be used or modifications and additions may be made to the described embodiment for performing the same function of the present invention without deviating there from. Therefore, the present invention should not be limited to any single embodiment, but rather construed in breadth and scope in accordance with the recitation of the appended claims.

What is claimed is:

1. A front-end signal generator for a hardware-in-the-loop simulator of a simulated analog electronic device, comprising
a computing device for calculating irradiance on an electro-optical or infrared detector utilized in said electronic device; and
a digital to analog converter for converting irradiance values into voltage that is injected into said electronic device's circuitry during simulation, wherein conversion of irradiance values into voltage is performed with low latency and a high dynamic range sufficient for hardware-in-the-loop simulation.

2. The front-end signal generator of claim 1, wherein said simulator is a digital scene and reticle hardware in the loop simulator.

3. The front-end signal generator of claim 1 wherein said computing device sums irradiance due to individual sources using double-precision floating point arithmetic.

4. The front-end signal generator of claim 1 wherein laser pulse inputs present during laser jammer countermeasures are emulated to increase dynamic ranges of said simulator.

5. The front-end signal generator of claim 1 wherein a computer-controlled signal injection is utilized for simulating said electronic device.

6. The front-end signal generator of claim 5 wherein said computer-controlled signal injection occurs via a front-panel-data-port.

7. The front-end signal generator of claim 1 wherein said electronic device is a missile.

8. A front-end signal generator for a hardware-in-the-loop simulator of a simulated missile, comprising
a computing device for calculating irradiance on an electro-optical or infrared detector utilized in said missile; and
a digital to analog converter for converting irradiance values into voltage that is injected into said missile's electronic circuitry during simulation, wherein conversion of irradiance values into voltage is performed with low latency and a high dynamic range sufficient for hardware-in-the-loop simulation.

9. The front-end signal generator of claim 8, wherein said simulator is a digital scene and reticle hardware in the loop simulator.

10. The front-end signal generator of claim 8 wherein said computing device sums irradiance due to individual sources using double-precision floating point arithmetic.

11. The front-end signal generator of claim 8 wherein laser pulse inputs present during laser jammer countermeasures are emulated to increase dynamic ranges of said simulator.

12. The front-end signal generator of claim 8 wherein a computer-controlled signal injection is utilized for simulating said missile.

13. The front-end signal generator of claim 12 wherein said computer-controlled signal injection occurs via a front-panel-data-port.

14. A method for generating front-end signal for a hardware-in-the-loop simulator of a simulated analog electronic device, comprising
calculating irradiance on an electro-optical or infrared detector utilized in said electronic device; and
converting irradiance values into voltage that is injected into said electronic device's circuitry during simulation, wherein conversion of irradiance values into voltage is performed with low latency and a high dynamic range sufficient for hardware-in-the-loop simulation.

15. The method of claim 14 wherein said simulator is a digital scene and reticle hardware in the loop simulator.

16. The method of claim 14 wherein said computing device sums irradiance due to individual sources using double-precision floating point arithmetic.

17. The method of claim 14 wherein laser pulse inputs present during laser jammer countermeasures are emulated to increase dynamic ranges of said simulator.

18. The method of claim 14 wherein a computer-controlled signal injection is utilized for simulating said electronic device.

19. The front-end signal generator of claim 18 wherein said computer-controlled signal injection occurs via a front-panel-data-port.

20. The front-end signal generator of claim 14 wherein said electronic device is a missile.
